(19) United States
(12) Patent Application Publication
(10) Pub. No.: US 2003/0014230 A1
(43) Pub. Date: Jan. 16, 2003

(54) Device and a method concerning the behaviour of a vehicle

(76) Inventor: Hans-Ove Hagelin, Linkoping (SE)

Correspondence Address: Swidler Berlin Shereff Friedman, Suite 300, 3000 K Street, Washington, DC, 20007, US

(21) Appl. No.: 10/169,382

(22) PCT Filed: Jan. 11, 2001
(86) PCT No.: PCT/SE01/00043

(30) Foreign Application Priority Data
Jan. 13, 2000 (SE) 00000877

(51) Int. Cl. G06G 7/48

(52) U.S. Cl. 703/8

(57) ABSTRACT

The invention concerns a device for the control of the behaviour of one or more simulated vehicles. The device comprises different units (10, 12, 16, 18, 20) for supervising the device, for presenting information and for making it possible to input instructions. The behaviour of the vehicle is controlled with the help of a number of rules (14). Each rule (14) comprises one or more premises (22) and conclusions (24). The premises (22) are assigned an indicator which may indicate different conditions, viz. that the premise (22) shall be true, that the premise (22) shall be false or that it does not matter whether the premise (22) is true or false. The invention also concerns a method of generating rules (14) suited to control the behaviour of a real or a simulated vehicle. The generation may be done by detecting the behaviour of a real/simulated vehicle controlled by a driver. Alternatively, the rules may be generated without detecting the behaviour of a driver-controlled vehicle.

### BACKGROUND OF THE INVENTION AND PRIOR ART

The present invention concerns a device for the control of the behaviour of one or more simulated vehicles, comprising:

a supervising unit arranged to control the behaviour of said at least one simulated vehicle, wherein the supervising unit comprises at least one storage member in which a set of rules for the behaviour of the simulated vehicle is stored,

a user interface comprising first means for presenting information to a user of the device and second means for inputting instructions to said supervising unit,

wherein the device is arranged such that a rule comprises one or more predetermined and pre-programmed premises which may either be true or false and one or more predetermined and preprogrammed conclusions.

This kind of device is already known. The supervising unit may suitably be a computer device. Said first means may for example be a screen or other projection device, a loud speaker, a possible device for the simulation of tilt and G-forces etc. Said second means may be a keyboard, a computer mouse, a joystick, microphones etc. The device may be a manned or an unmanned simulator. A manned simulator has a position intended for a driver, pilot or the same who for example may be trained in the simulator. An unmanned simulator may for example be used to simulate the co-operation of several different vehicles and the behaviour of theses vehicles in different situations.

An example of a simulator device is a system with the name ITEMS™ which is provided by CAE Electronics Ltd. This simulator device comprises the possibility to show a window with a set of rules that control the behaviour of a simulated vehicle. The rules are written at a program language level. Rules which control the device may be shown in the form of a list of rules. In each rule one or more premises and then one or more conclusions are thereby shown. All conclusions in a rule are carried out if all premises are fulfilled, i.e. if all premises are true. The different rules are executed in a temporal sequence in the order that they are listed, i.e. a flat rule structure is used.

Prior known devices for the simulation of the behaviour of one or more vehicles suffer from different problems. For example, it is often difficult for a user who is not experienced in programming to make changes in the rule system. It may thereby be difficult to get an overview over the rules that control the vehicle. Furthermore, it may be difficult for a user to realise to what consequences for the behaviour of the vehicle in different situations that an added rule in a longer list of rules leads. Furthermore, it may be time-consuming and difficult to create new sets of rules that realistically describe the behaviour of the vehicle or of a driver of the vehicle.

### SUMMARY OF THE INVENTION

A first purpose with the present invention is to achieve an improved device for the simulation of the behaviour of one or more vehicles. The device should thereby be such that a user should be able in a relatively simple manner to change the rules that control the behaviour of the vehicle or vehicles. A purpose thereby is that the user should be able to change the conditions for the premises that form part of a rule. A second purpose of the invention is to create a method in order to be able to generate rules in a simple manner for the behaviour of a vehicle and/or of the driver of a vehicle, wherein said rules are suited to be used to control the behaviour of a real or a simulated vehicle.

The first purpose of the invention is achieved by the device initially described which is characterised in that the device is arranged such that each premise in the rule is assigned an indicator which may indicate three different conditions, viz. a first condition which is that the premise shall be true, a second condition which is that the premise shall be false and a third condition which is that it does not matter whether the premise is true or false, wherein at least one conclusion is meant to be executed if all of said premises fulfil the conditions set by the assigned indicators.

Since the premises are assigned said indicators, it is possible to in a simple manner make changes in a rule by changing one or more of said indicators. In order to make a change in a rule it is thus not always necessary to add or to remove premises, it may instead be sufficient to change one or more of said indicators. The indicators may thus be seen as a kind of operator which determines the function of the respective premise in the rules when the device is operated.

In this context the following should be noted. The simulated vehicle or vehicles, the behaviour of which is to be controlled, may be all kinds of vehicles, for example cars, boats, aeroplanes, helicopters, etc. Furthermore, the device may concern the simulation with or without a user who is being trained to operate a vehicle. This means that the device may concern the behaviour of one or more vehicles and, in case several vehicles are involved, their influence on the behaviour of each other based on the set of rules without any real person acting as a driver of a vehicle. Alternatively, the device may be used in a simulator where one or more people act as drivers of the vehicle or vehicles. For example, a person may thereby be trained to act as a driver of a vehicle in a simulator where there are also other simulated vehicles. It should also be noted that when in the following the “behaviour of a vehicle” is mentioned, this behaviour may indirectly include the behaviour of a driver, since the behaviour of the vehicle may depend on actions of a driver.

According to a preferred embodiment of the device, the device is arranged such that each conclusion in the rule is assigned an indicator which may indicate two different cases, a first case which indicates that the conclusion shall be executed or a second case which indicates that the conclusion shall not be executed, wherein a conclusion is meant to be executed if all of said premises in the rule fulfil the conditions set by the assigned indicators and the indicator of the conclusion indicates said first case. Since also the conclusions are assigned indicators, rules may thus also be changed by changing the indicators of the conclusions. In order to make changes in the conclusion of a rule, it is thus not always necessary to add or to remove complete conclusions, it may instead be sufficient to change one or more of said indicators.

According to a further preferred embodiment of the device, the device is arranged to show, on command from a user, one or more of said rules with the help of said user interface, wherein the device is arranged such that a user with the help of said second means of the user interface may change the indications of said indicators. Said rules may thereby for example be shown as a window on a screen. The user may thereby study the rules and carry out suitable changes of the rules.

According to a further embodiment of the device, the device is arranged such that the user may change said indicators by one or a few depressions of a key or a button. For example, the user may change said indicators by one or more clicks with a computer mouse which form part of the device. By a few simple clicks, said indications, and thereby said rules, may be changed.

According to a further embodiment of the device, the device is arranged such that at least some of said premises and/or conclusions comprise one or more parameters which may be changed, wherein the device is arranged to present, in response to a command from a user via said user interface, a parameter window which shows at least one premise or conclusion and wherein the user with the help of said user interface may change the parameter of parameters in said premise or conclusion. With the help of such a parameter window, a user may thus in a simple and clear manner observe and change a premise or a conclusion. A parameter may for example consist of a numerical value. Suitably, a parameter window comprises only one premise or conclusion.

According to a further embodiment of the device, the device is arranged such that the behaviour of said at least one vehicle is divided into a plurality of states for different situations in which the vehicle may be, wherein said plurality of states are divided into a network or into a hierarchy of states, wherein the device is arranged to show, in response to a command from a user via said user interface, a window which illustrates said network or hierarchy of states. Through this embodiment, a user can get a good overview over the different situations in which a vehicle may be. This makes it easier to make changes in the rules that control the vehicle in different situations.

According to a further embodiment of the device, the device is arranged such that a user via said user interface may create new states and/or remove states. A user may thereby in a simple manner add or remove different situations in which a vehicle may be without the user loosing the overview over the different states.

According to a further embodiment of the device, the device is arranged such that each state comprises a plurality of said rules, which are divided into one or more rule-blocks which concern different aspects of the state, wherein the rule or rules that form part of a certain rule-block on command from a user via said user interface are shown as a rule-block window. A user may thus get a good overview over the rules which form part of a rule-block without being distracted by other rules which are not relevant to the rule-block in question.

According to a further embodiment of the device, the device is arranged to show, in said rule-block window, all premises and conclusions which form part of the different rules which form part of that rule-block, wherein for each rule in the rule-block said indications which indicate said conditions and cases are shown as marks for the respective premises and conclusions. A user of the device may thus get a good overview over all premises and conclusions which are relevant to the rule-block in question, By said marks, a good overview is also achieved over the relevance of the different premises and conclusions to the different rules in the rule-block.

According to a further embodiment of the device, the device is arranged such that each rule in the rule-block is represented by a column in said rule-block window, in which column said marks are shown. Since a rule is thus represented by a column, the overview over the rule is further improved. Furthermore, a user may suitably make changes in said rules by changing said marks in the columns. This may for example be done in a simple manner by clicking with the computer mouse on the relevant positions in the columns.

According to a further embodiment of the device, the device is arranged such that a user via said user interface may add or remove premises or conclusions to or from said rules. A user thus not only has the possibility to change the indications of the premises and the conclusions which form part of a rule. The user may furthermore add or remove premises and conclusions.

According to a further embodiment of the device, the device is arranged to show, in response to a command from a user, a window which comprises all premises or conclusions which are available to form part of the rules in a state or a rule-block. Thereby, a user may get a good overview over the premises or conclusions.

The above second purpose of the invention is achieved by a method of generating rules for the behaviour of a vehicle and/or of a driver of a vehicle, wherein said rules are suited to be used to control the behaviour of a real or a simulated vehicle, wherein said method is characterised in that it comprises:

establishing the behaviour of a vehicle and/or of a driver of a vehicle by determining whether a plurality of predefined and pre-programmed premises are fulfilled and whether a plurality of predefined and pre-programmed conclusions are carried out at different moments in time during an imaginary or real operation of said vehicle,

treating the result of said establishment comprising the creation of a plurality of rules which describe the behaviour of said vehicle and/or of the driver of the vehicle in different situations, wherein each of said rules comprises one or more premises of the above-mentioned kind which may be true or false and one or more conclusions of the above-mentioned kind which describe a behaviour or an action which is carried out when the different premises are true or false.

Through this method, rules may be created in a simple manner by establishing a behaviour based on pre-programmed premises and conclusions. A rule thus suitably includes those of the pre-programmed premises that are shown to be relevant to a behaviour in the form of one, or possibly several, of the pre-programmed conclusions.

According to an embodiment of the method, said establishment is done by detecting the behaviour of a real vehicle and/or of a driver of a vehicle. The detection may be done directly when the vehicle is operated. Alternatively, the behaviour of a driver/vehicle may be stored in a storage medium for later detection and treatment. These manners of establishing the behaviour may be called that the establishment is done on-line. According to another alternative, the establishment may be done without the detection of the behaviour of a real vehicle, for example in that a driver is questioned concerning the behaviour of a vehicle, and that it is thereby clarified which of the predefined premises and conclusions that are fulfilled during different moments in the operation of the vehicle. This manner of establishing the behaviour may be called “off-line”.

According to a further embodiment of the method, said treatment comprises checking whether certain premises are necessary of redundant, wherein redundant premises are not included in the created rules. By theses embodiments, it is achieved that the rules become easier to overview in that none-necessary premises are excluded.

Further preferred embodiments of the method are clear from the further dependent claims. By theses embodiments, advantages corresponding to those which have been described above in connection with the device are achieved.

### SHORT DESCRIPTION OF THE DRAWINGS

The present invention will now be explained with the. help of embodiments given as examples and with reference to the annexed drawings.

FIG. 1 shows schematically a device according to the invention in the form of a blockdiagram.

FIG. 2 shows an example of a window of states which the device according to the invention is arranged to show.

FIG. 3 shows an example of a rule-block window which the device according to the invention is arranged to show.

FIG. 4 shows an example of a parameter window which the device according to the invention is arranged to show.

FIG. 5 shows an example of a window with conclusions which the device according to the invention is arranged to show.

FIG. 6 shows schematically a flow chart for carrying out a method according to the invention.

### DESCRIPTION OF EMBODIMENTS OF THE INVENTION

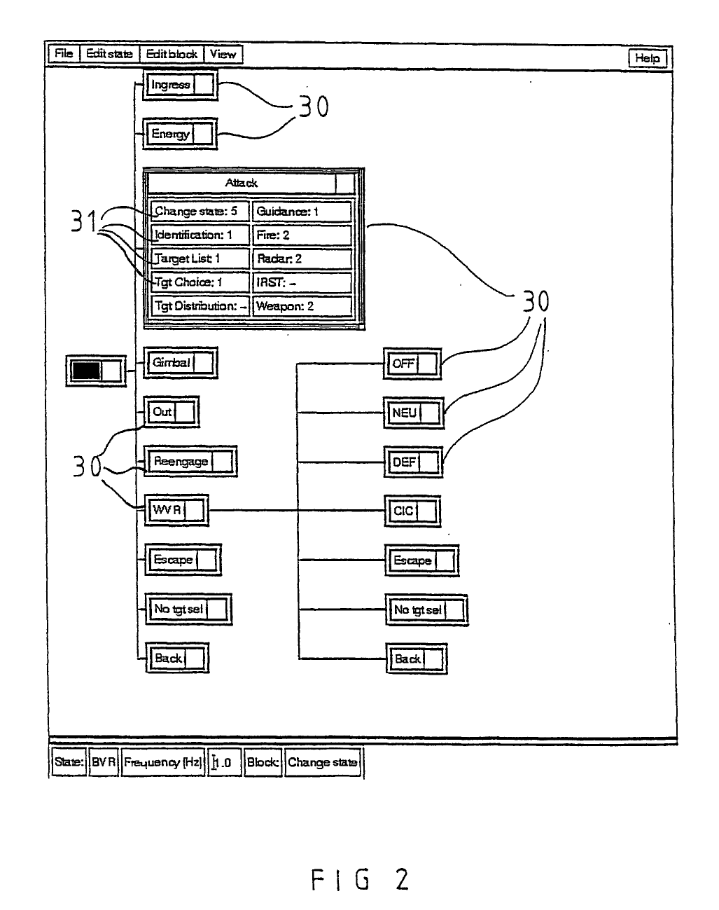

An embodiment of the invention will now be described with reference to the drawings. The embodiment which is here described concerns primarily the simulation of the behaviour of one or more aircrafts. The invention is however not limited to aircrafts, but may be applied for controlling the behaviour of any simulated vehicle or craft. The device according to the invention is inter alia arranged to show different windows. Examples of such windows are shown in FIGS. 2-5. The invention is in no way limited to the text that is present in these figures. This text should only be seen as symbolic. Furthermore, devices for the simulation of the behaviour of vehicles are well known to the person skilled in the art. It will therefore below not be described in detail how such devices are constructed. Instead, the description below concentrates on the aspects of the device that are particular to the present invention.

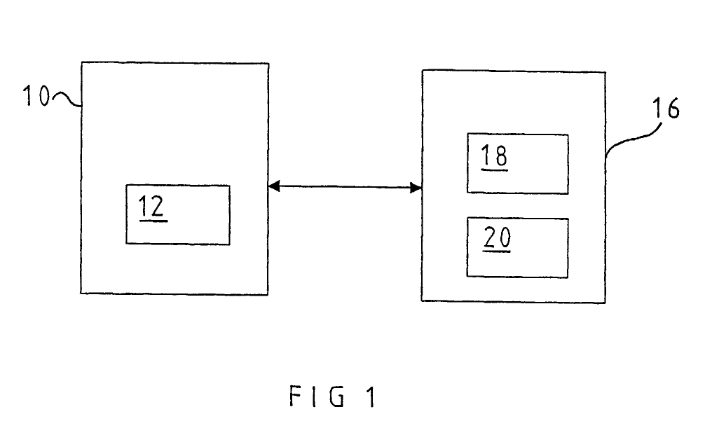

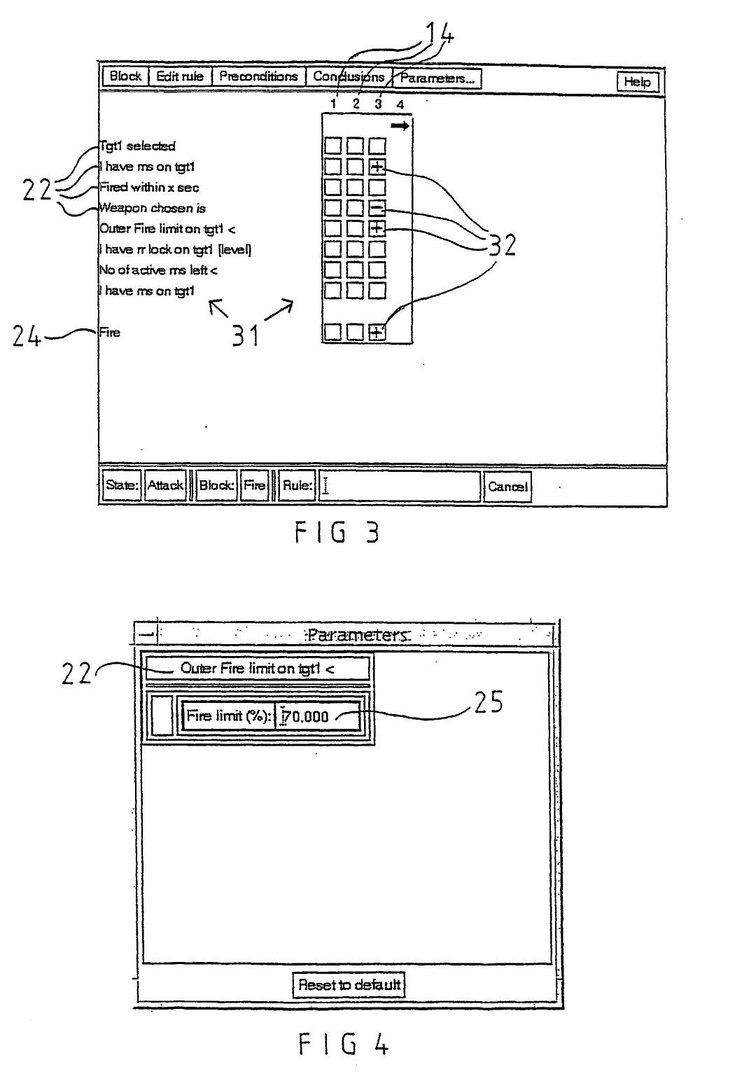

FIG. 1 shows schematically a device according to the invention. The device comprises a supervising unit 10. Such a supervising unit 10 may consist of a computer device. The supervising unit 10 comprises at least one storage member 12. In this storage member 12 a set of rules 14 (see FIG. 3) are stored which control the behaviour of the simulated vehicle or vehicles. The device also comprises a user interface 16. The user interface 16 comprises first means 18 for presenting information to a user. This first means 18 may for example include a screen, a load speaker or similar devices. The user interface 16 also comprises second means 20 for inputting instructions to the supervising unit 10. This second means 20 may for example consist of a keyboard, a joystick, a computer mouse or the same.

For facilitating for a user to get an overview over the function of the device and in order to in a simple manner be able to select different situations in the behaviour of a vehicle, the device is arranged such that the control of the vehicle is divided into a plurality of states 30 (see FIG. 2). These states 30 represent different situations in which the vehicle may be or different phases of the behaviour of a vehicle. The states are suitably arranged in a network or in a hierarchy of states. FIG. 2 shows such a hierarchy of states. A certain state 30 may thus have 0, 1 or several substates. For example, FIG. 2 shows that the state that is marked with “Out” does not have any substate. On the other hand, the state that is marked with “WVR” has seven different substates. The device is arranged to show, in response to a command from a user, for example via the keyboard or the computer mouse, a window (FIG. 2) which illustrates the network or the hierarchy of states 30.

The device is also arranged such that a user may create new states 30 or remove states 30. States 30 may for example be added or removed by first clicking on a menu in the upper part of the window which illustrates said network or hierarchy of states 30. Alternatively, it is possible that new states 30 are created or that states 30 are removed by clicking with the computer mouse directly on the states 30 that are shown in the window. Concerning the hierarchy of states 30, for example the following grouping is possible: a highest level where it is stated which kind of aeroplane is involved, a second level which indicates the different kinds of missions that the aeroplane may carry out, a third level that states different phases of the different missions and so on.

The behaviour of the vehicle in a certain state 30 is controlled by a plurality of rules 14. The rules 14 that form part of a state 30 may be divided into a plurality of rule-blocks 31. FIG. 2 thus shows that the state 30, that is denoted “Attack”, comprises ten rule-blocks 31. Each rule-block 31 may concern a certain aspect of the state 30. Each rule-block 31 comprises thus the rule or rules 14 which are relevant to the rule-block 31 in question.

The device is arranged to show, in response to a command from a user via the user interface 16, a rule-block 31 in more detail with the help of a rule-block window (FIG. 3). Each rule 14 comprises one or more predetermined premises 22 which may either be fulfilled or not fulfilled, i.e. they may be true or false. Furthermore, a rule 14 comprises one or more predetermined conclusions 24. The rule-block window in FIG. 3 comprises three rules 14 marked with 1, 2 and 3. Each rule 14 is thus represented by a column in the rule-block window. In the rule-block window all premises 22 and conclusions 24 that form part of the different rules 14 that form part of the rule-block 31 are shown. In a similar manner as concerning the states 30, the device is arranged such that a user may add or remove premises 22 or conclusions 24 to or from a the different rules 14.

Each premise 22 in a rule is assigned an indicator which may indicate three different conditions, viz. a first condition which means that the premise 22 shall be true, a second condition which means that the premise 22 shall be false and a third condition which means that it does not matter whether the premise 22 is true or false. Furthermore, suitably each conclusion 24 in a rule 14 is assigned an indicator which may indicate two different cases: a first case which indicates that the conclusion 24 shall be carried out and a second case which indicates that the conclusion 24 shall not be carried out. A conclusion 24 is thus executed if all mentioned premises 22 that are included in the rule 14 fulfil the conditions set by the indicators and the indicator of the conclusion 24 indicates that the conclusion 24 shall be executed. The different indications are marked in the columns for the respective rule 14 in the rule-block window. FIG. 3 shows examples of such marks 32 for the rule 14 which is marked by 3. The mark “+” indicates in this case that a premise 22 shall be true or that a conclusion 24 shall be executed. The mark “−” indicates that a premise 22 shall be false. A white square indicates that it does not matter whether the premise 22 in question is false or true. Concerning the rule 3 in FIG. 3 it is thus the case that the conclusion 24 is executed if the second and the fifth premises 22 are true and the forth premise 22 is false. Said marks 32 may of course have another appearance than the shown appearance. Thus, the marks 32 may for example constitute a black, a white or a grey square.

The device is arranged such that a user in a simple manner may change the different indications for the premises 22 and the conclusions 24. For example, these indications may be changed in that a user clicks on the computer mouse.

The device is also arranged such that a user may change the possible parameters 25 which form part of the premises 22 or the conclusions 24. This may for example be done in that the user clicks on a menu in the upper part of the rule-block window. Thereby, a parameter window (see FIG. 4) can be shown. This parameter window shows a premise 22 or a conclusion 24. In FIG. 4 a premise 22 is shown. The parameter 25 or the parameters 25 may thereby be changed by a user. The device is also arranged such that a user in a simple manner may add or remove rules 14 as well as add or remove premises 22 or conclusions 24 that form part of the different rule-blocks 31. An advantage with the present invention is that the premises 22 and the conclusions 24 are written in a natural language and are thus easy to understand for a user without special programming knowledge

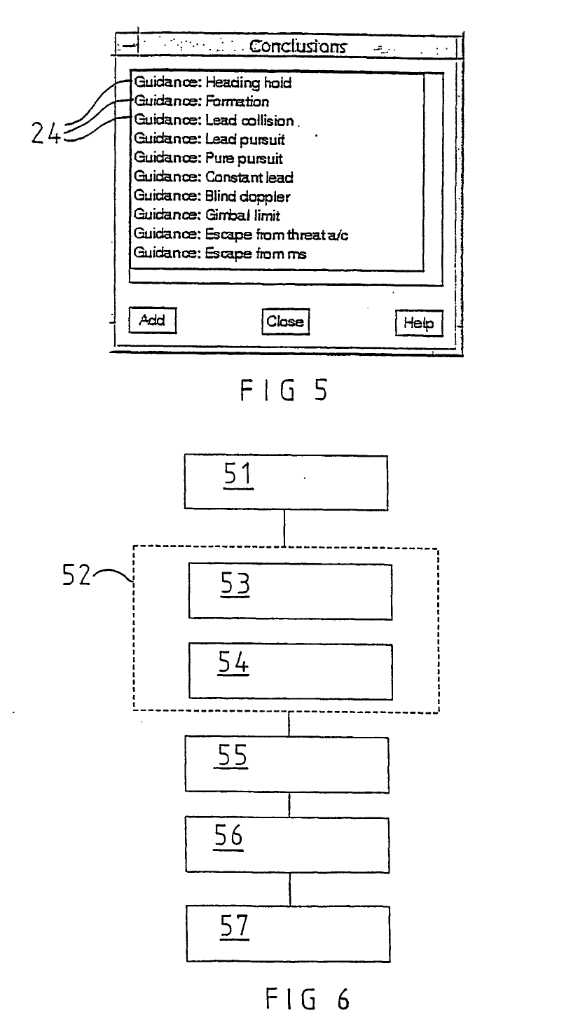

The device is also arranged to show, in response to a command from a user, a window (see FIG. 5) which comprises all premises 22 or conclusions 24 that are available for the rules 14 for a certain state 30 or rule-block 31. FIG. 5 thus shows the conclusions 24 which are available for a certain rule-block 31.

It should be noted that it may vary from state 30 to state 30 which rule-blocks 31 that form part thereof. However, preferably all states 30 comprise a kind of rule-block 31 which describes the rules 14 for when a transition to another state 30 takes place.

When the device is operated for controlling the behaviour of one or more simulated vehicles, the different rules 14 in a rule-block 31 are suitably dealt with in order. It is thereby for example possible to start with the first premise 22 in the first rule 1 whereafter the remaining premises 22 and the conclusions 24 in the first rule 1 follow. Thereafter follows the same order for the second rule 2 etc.

The different rule-blocks 31 which form part of a state 30 may suitably be gone through in order. The device also comprises means with which a user may set with which frequency the different rules 14 shall be gone through. Suitably the device is arranged such that the rule-block is left as soon as a rule is executed, i.e. as soon as a conclusion, or possibly several conclusions, are executed.

The invention also concerns a method of generating rules 14 for the behaviour of a vehicle and/or of a driver of a vehicle. Said rules 14 are thereby suited to be used to control the behaviour of a real or a simulated vehicle. For example, such a method is suited to generate rules 14 which may be used in the above described device. The different steps which may be included in this method are shown in FIG. 6. It should be noted that the steps do not necessarily have to be performed in the order that is shown in FIG. 6.

This method comprises the establishment 51 of the behaviour of a vehicle and/or of a driver of a vehicle. The establishment 51 may be done by detecting the behaviour of a driver or a vehicle when the driver operates a real vehicle or a manned simulator. The detection may for example be carried out with the help of a computer which supervises the behaviour of the vehicle/driver during the operation. It may thus for example be detected which operations a driver carries out in different situations and which parameters that describe the state of the vehicle in these situations. It is thereby checked whether a plurality of predefined and pre-programmed premises 22, similar to those described above, are fulfilled and whether a plurality of predefined and pre-programmed conclusions 24 are carried out at different moments in time when the vehicle is operated. Alternatively, the establishment 51 may be done off-line, for example in that a driver is questioned concerning the behaviour of a vehicle, wherein it is thereby clarified which of the predefined and pre-programmed premises 22 and conclusions 24 that are fulfilled during different moments in the operation of the vehicle.

Furthermore, the result of the above establishment is treated 52. Thereby a number of rules 14 are created 53, which rules describe the behaviour of the vehicle and/or of the driver in different situations. Each of these rules 14 comprises one or more of said premises 22 which may be true or false and one or more of said conclusions 24 which describe a behaviour or an action that is carried out when the different premises 22 are true or false. Furthermore, it is checked 54 whether certain premises 22 are redundant. The redundant premises 22 are suitably removed. Furthermore, said behaviour of the vehicle and/or of the driver is suitably divided 55 into different states 30 which describe different situations or missions that are carried out.

The treatment 52 of the result of the establishment 51 is suitably performed with the help of a computer. Through this treatment 52 a number of rules 14 may thus be obtained, which comprise a number of premises 22 and one or more conclusions 24. The conclusions 24 thus describe a certain behaviour or action that is carried out when the different premises 22 are true or false. The states 30 obtained through said treatment 52 and the rules 14 within the states 30 may then be used in a device of the kind described above. Alternatively, the rules 14 may be used for controlling a real vehicle. Suitably, the states 30 are thereby structured 56 in a network or in a hierarchy of states 30 in a similar manner as has been described above. Similarly, the rules 14 are suitably arranged 57 in a number of rule-blocks 31 which form part of the different states 30. Furthermore, the different premises 22 and conclusions 24 in the rules 14 which form part of the respective rule-block 31 are assigned indicators concerning the different conditions and cases which have been described in connection with the device.

The present invention is not limited to the described embodiments. The invention may thus be modified and varied within the scope of the following claims.

1. A device for the control of the behaviour of one or more simulated vehicles, comprising:
a supervising unit (10) in the form of a computer device arranged to control the behaviour of said at least one simulated vehicle, wherein the supervising unit (10) comprises at least one storage member (12) in which a set of rules (14) for the behaviour of the simulated vehicle is stored,
a user interface (16) comprising first means (18) for presenting information to a user of the device and second means (20) for inputting instructions to said supervising unit (10),
wherein the device is arranged such that a rule (14) comprises one or more predetermined and pre-programmed premises (22) which may either be true or false and one or more predetermined and pre-programmed conclusions (24), characterised in that the device is arranged such that each premise (22) in the rule is assigned an indicator which may indicate three different conditions, viz. a first condition which is that the premise (22) shall be true, a second condition which is that the premise (22) shall be false and a third condition which is that it does not matter whether the premise (22) is true or false, wherein at least one conclusion (24) is meant to be executed if all of said premises (22) fulfil the conditions set by the assigned indicators.

2. A device according to claim 1, characterised in that the device is arranged such that each conclusion (24) in the rule (14) is assigned an indicator which may indicate two different cases, a first case which indicates that the conclusion (24) shall be executed or a second case which indicates that the conclusion (24) shall not be executed, wherein a conclusion (24) is meant to be executed if all of said premises (22) in the rule (14) fulfil the conditions set by the assigned indicators and the indicator of the conclusion (24) indicates said first case.

3. A device according to claim 1 or 2, characterised in that the device is arranged to show, on command from a user, one or more of said rules (14) with the help of said user interface (16), wherein the device is arranged such that a user with the help of said second means (20) of the user interface (16) may change the indications of said indicators.

4. A device according to claim 3, characterised in that the device is arranged such that the user may change said indications by one or a few depressions of a key or a button.

5. A device according to any of the preceding claims, characterised in that the device is arranged such that at least some of said premises (22) and/or conclusions (24) comprise one of more parameters (25) which may be changed, wherein the device is arranged to present, in response to a command from a user via said user interface (16), a parameter window (FIG. 4) which shows at least one premise (22) or conclusion (24) and wherein the user with the help of said user interface (16) may change the parameter or parameters in said premise (22) or conclusion (24).

6. A device according to any of the preceding claims characterised in that the device is arranged such that the behaviour of said at least one vehicle is divided into a plurality of states (30) for different situations in which the vehicle may be, wherein said plurality of states (30) are divided into a network or a hierarchy of states (30), wherein the device is arranged show a window (FIG. 2), in response to a command from a user via said user interface (16), which illustrates said network or hierarchy of states.

7. A device according to claim 6, characterised in that the device is arranged such that a user via said user interface (16) may create new states (30) and/or remove states (30).

8. A device according to claim 6 or 7, characterised in that the device is arranged such that each state (30) comprises a plurality of said rules (14), which are divided into one or more rule-blocks (31) which concern different aspects of the state (30), wherein the rule or rules (14) which form part of a certain rule-block (31) are shown as a rule-block window (FIG. 3) on a command from a user via said user interface (16).

9. A device according to claim 8, characterised in that the device is arranged to show, in said rule-block window (FIG. 3), all premises (22) and conclusions (24) which form part of the different rules (14) which form part of that rule-block (31), wherein for each rule (14) in the rule-block (31) said indications which indicate said conditions and cases are shown as marks (32) for the respective premises (22) and conclusions (24).

10. A device according to claim 9, characterised in that the device is arranged such that each rule (14) in the rule-block (31) is represented by a column in said rule-block window (FIG. 3) in which column said marks (32) are shown.

11. A device according to any of the preceding claims, characterised in that the device is arranged such that a user via said user interface (16) may add or remove premises (22) or conclusions (24) to or from said rules (14).

12. A device according to any of the preceding claims, characterised in that the device is arranged to show, in response to a command from a user, a window (FIG. 5) which comprises all premises (22) or conclusions (24) which are available to form part of the rules (14) in a state (30) or rule-block (31).

13. A method of generating and using rules (14) for the behaviour of a vehicle and/or of a driver of a vehicle, wherein said rules (14) are suited to be used to control the behaviour of a real or a simulated vehicle, wherein said method is characterised in that it comprises:
establishing (51) the behaviour of a vehicle and/or of a driver of a vehicle by determining whether a plurality of predefined and pre-programmed premises (22) are fulfilled and whether a plurality of predefined and pre-programmed conclusions (24) are carried out at different moments in time during an imaginary or real operation of said vehicle,
treating (52) with the help of a computer the result of said establishment comprising the creation (53) of a plurality of rules (14) which describe the behaviour of said vehicle and/or of the driver of the vehicle in different situations, wherein each of these rules (14) comprises one or more premises (22) of the above-mentioned kind which may be true or false and one or more conclusions (24) of the above mentioned kind which describe a behaviour or an action which is carried out when the different premises (22) are true or false and using the generated rules in a device according to any of the preceding claims or in a real vehicle.

14. A method according to claim 13, characterised in that said establishment (51) is done by detecting the behaviour of a real vehicle and/or of a driver of a vehicle.

15. A method according to claim 13 or 14, characterised in that said treatment (52) comprises checking (54) whether certain premises (22) are necessary or redundant, wherein redundant premises (22) are not included in the created rules (14).

16. A method according to any of the claims 13-15, characterised in that the behaviour of the vehicle and/or of the driver is divided (55) into different states (30) for different situations or phases of said behaviour, and in that said states (30) are structured (56) as a network or as a hierarchy of states.

17. A method according to claim 16, characterised in that the rules (14) which form part of a state (30) are arranged (57) in the form of one or more rule-blocks (31).

18. A method according to claim 17, characterised in that in said rule-block (31) all premises (22) and conclusions (24), which are included in the different rules (14) in the rule-block (31), are included, wherein for each rule (14) in the rule-block it is the case that each premise (22) in the rule-block (31) is assigned an indicator which may indicate three different conditions, viz. a first condition which is that the premise (22) shall be true, a second condition which is that the premise (22) shall be false and a third condition which is that it does not matter whether the premise (22) is true or false, and wherein for each rule (14) in the rule-block (31) it is the case that each conclusion (24) in the rule-block (31) is assigned an indicator which may indicate two different cases, a first case which indicates that the conclusion (24) shall be carried out or a second case which indicates that the conclusion (24) shall not be carried out.
